(19) United States
(12) Patent Application Publication
(10) Pub. No.: US 2012/0245891 A1
(43) Pub. Date: Sep. 27, 2012

(54) ELECTRONIC APPARATUS SYSTEM FOR CALCULATING FAILURE PROBABILITY OF ELECTRONIC APPARATUS

(75) Inventors: Takeichiro NISHIKAWA, Yokohama-shi (JP); Minoru NAKATSUGAWA, Yokohama-shi (JP); Ryusei SHINGAKI, Chiba-shi (JP)

(73) Assignee: KABUSHIKI KAISHA TOSHIBA, Tokyo (JP)

(21) Appl. No.: 13/427,106

(22) Filed: Mar. 22, 2012

Related U.S. Application Data
(63) Continuation of application No. PCT/JP2009/066566, filed on Sep. 24, 2009.

(51) Int. Cl. G06F 17/18

(52) U.S. Cl. 702/181

(57) ABSTRACT

There is provided an electronic apparatus system. The system includes: an electronic apparatus; and a server configured to receive usage information about usage status of the electronic apparatus. The server includes: a first database; a second database; a writer configured to store the usage information in the first database and to write a flag value into the second database, wherein the flag value indicates whether or not the usage information is transmitted from the electronic apparatus through a network; a generator configured to generate a first parameter for calculating a failure probability of the electronic apparatus, based on the usage information and repair information of the electronic apparatus, wherein the repair information is stored in the server in advance; and a transmitter configured to transmit the first parameter to the electronic apparatus.

This is a Continuation Application of PCT Application No. PCT/JP2009/066566, filed on Sep. 24, 2009, which was published under PCT Article 21(2) in Japanese, the entire contents of which are incorporated herein by reference.

### BACKGROUND

1. Field

Embodiments described herein relate to an electronic apparatus system for calculating the probability of an electronic apparatus.

2. Description of the Related Art

JP-A-2006-113961 discloses a technique which records log information related to, for example, the operation of the user or the state of each hardware component on a recording medium, predicts a future operating state on the basis of the log information recorded on the recording medium, and performs a process corresponding to the operating state.

However, in the technique disclosed in JP-A-2006-113961, it is difficult to appropriately acquire the information of an electronic apparatus and thus appropriately know the failure probability of the electronic apparatus. In addition, JPA-2006-113961 does not disclose a technique capable of appropriately knowing the failure probability with one system.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention:

FIG. 1 is a block diagram illustrating an electronic apparatus system 10 according to a first embodiment;

FIG. 2 is a diagram illustrating the information of an electronic apparatus read by sensors;

FIG. 3 is a diagram illustrating the collected information of an electronic apparatus 20;

FIG. 4 is a diagram illustrating the relationship between a transmission number and a transmission date;

FIG. 5 is a diagram illustrating a flag value;

FIG. 6 is a diagram illustrating the relationship between the serial number and the flag value of the electronic apparatus 20;

FIG. 7 is a block diagram illustrating the connection structure between an external electronic apparatus and a server 30;

FIG. 8 is a diagram illustrating repair information of an electronic apparatus;

FIG. 9 is a diagram illustrating the relationship between a sample number and the information of the electronic apparatus;

FIG. 10 is a flowchart illustrating the operation of the electronic apparatus system 10 according to the first embodiment;

FIG. 11 is a block diagram illustrating an electronic apparatus system 300 according to a second embodiment;

FIG. 12 is a diagram illustrating a specific set of electronic apparatuses; and

FIG. 13 is a flowchart illustrating the operation of the electronic apparatus system 300 according to the second embodiment.

### DETAILED DESCRIPTION

According to an embodiment, there is provided an electronic apparatus system. The system includes: an electronic apparatus; and a server configured to receive usage information about usage status of the electronic apparatus. The server includes: a first database; a second database; a writer configured to store the usage information in the first database and to write a flag value into the second database, wherein the flag value indicates whether or not the usage information is transmitted from the electronic apparatus through a network; a generator configured to generate a first parameter for calculating a failure probability of the electronic apparatus, based on the usage information and repair information of the electronic apparatus, wherein the repair information is stored in the server in advance; and a transmitter configured to transmit the first parameter to the electronic apparatus.

Hereinafter, exemplary embodiments of the invention will be described with reference to the accompanying drawings. In the following drawings, the same components are denoted by the same reference numerals and a description thereof will not be repeated herein.

### First Embodiment

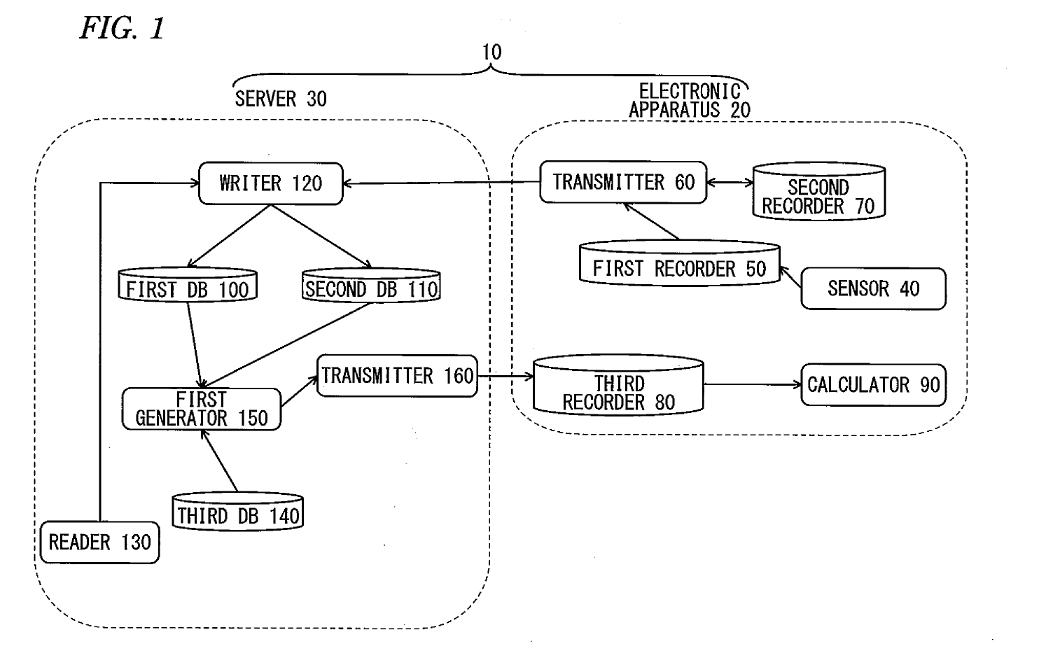

FIG. 1 is a block diagram illustrating an electronic apparatus system 10 according to a first embodiment of the invention. In this embodiment, it is assumed that an electronic apparatus 20 is connected to a server 30 by the Internet. The server 30 is connected to a plurality of electronic apparatuses through the Internet. For simplicity of explanation, it is assumed that one electronic apparatus 20 is connected to the server 30 through a network. In addition, the electronic apparatus 20 is, for example, a PC (Personal Computer), a television, or a microwave oven.

The electronic apparatus system 10 includes the electronic apparatus 20 and the server 30. The electronic apparatus 20 includes a plurality of sensors 40 that measures the state of the electronic apparatus 20, a first recorder 50 that records information measured by the sensors 40 in time series, a transmitter 60 that transmits the information recorded by the first recorder 50 to the server 30, a second recorder 70 that records a transmission history when the transmitter 60 transmits information, a third recorder 80 that records parameters for failure probability calculated in the server 30, and a calculator 90 that calculates the failure probability of the electronic apparatus from the parameters recorded by the third recorder 80. The server 30 includes a writer 120 that receives the information recorded by the first recorder 50 of the electronic apparatus 20, stores the information in a first database (hereinafter, referred to as a DB) 100, and writes a flag value for identifying the information of the electronic apparatus stored in a second DB 110 and the first DB 100, a reader 130 that reads the information of the electronic apparatus through the network, a third DB 140 that stores repair information of the electronic apparatus in advance, a first generator 150 that generates parameters used to calculate the failure probability of the electronic apparatus from the information of the electronic apparatus stored in the first DB 100, the repair information of the electronic apparatus stored in the third DB 140, and the flag value written in the second DB 110, and a transmitter 160 that transmits the parameters generated by the first generator 150 to the third recorder 80 of the electronic apparatus 20.

The sensor 40 measures, for example, the start time, the continuous start time, the maximum impact value, and a writing error to an HDD (hard disk drive) of the electronic apparatus 20 and records them in the first recorder 50. For example, the sensor 40 is a program stored in the electronic apparatus 20. In this case, the sensor 40 measures the start time or the continuous start time. In addition, a thermometer or an impact meter may be used as the sensor 40.

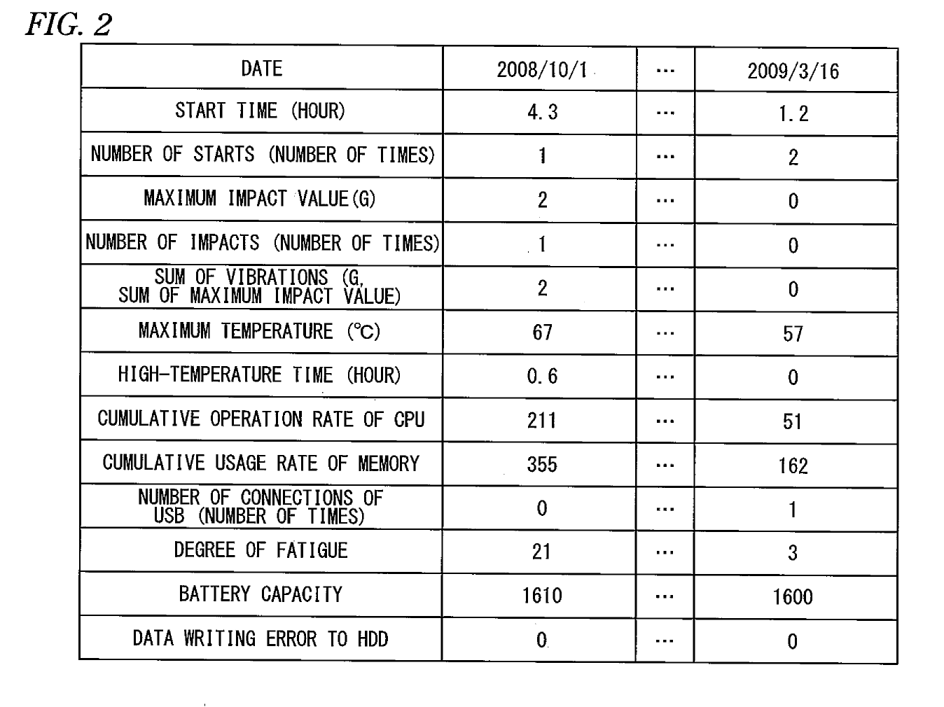

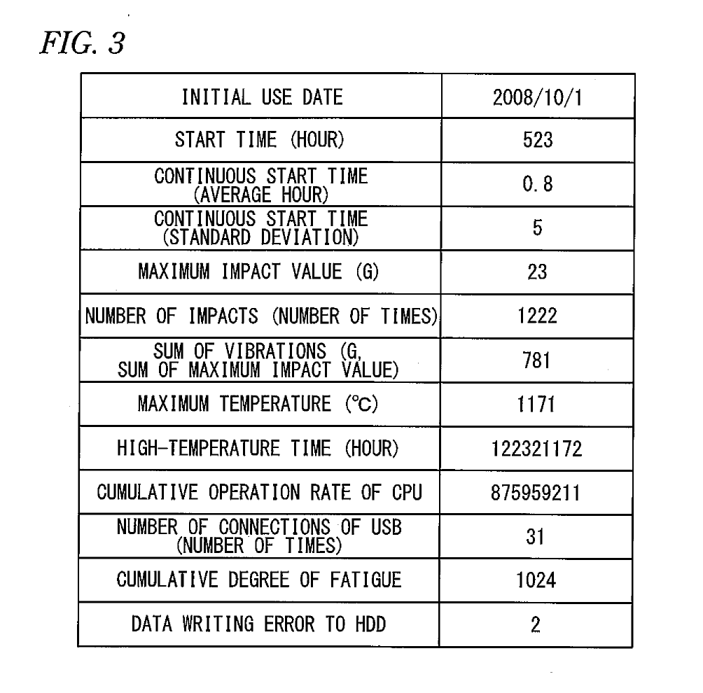

As shown in FIGS. 2 and 3, the first recorder 50 collects and records daily information about, for example, the start time, the continuous start time, the maximum impact value, and the writing error to the HDD of the electronic apparatus 20, and information about, for example, the start time, the continuous start time, and the maximum impact value of the electronic apparatus 20 until the latest measurement date, which are measured by the sensors 40.

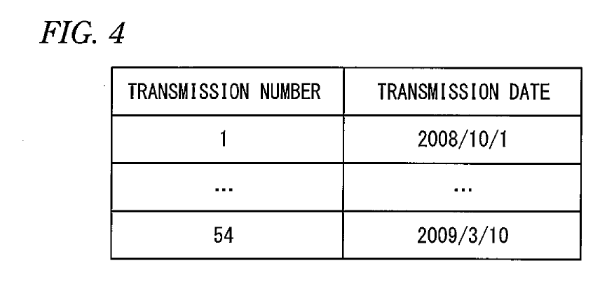

The transmitter 60 transmits the information recorded in the first recorder 50 to the writer 120 of the server 30 according to schedule (for example, the transmission of information at 10:00 once a day or the transmission of information when the electronic apparatus 20 starts at the beginning after every Monday), and records a transmission number and a transmission date as the transmission history in the second recorder 70, as shown in FIG. 4. The transmission numbers 1, 2, 3, . . . shown in FIG. 4 are given in order of transmission time. The transmitter 60 may transmit the information to the writer 120 in response to instructions from the user, regardless of schedule.

The writer 120 stores the information of the electronic apparatus transmitted from the reader 130 and the transmitter 60 in the first DB 100, and stores the flag value and the serial number of the electronic apparatus 20 corresponding to the flag in the second DB 110. The flag value is for identifying the relationship between the information of the electronic apparatus stored in the first DB 100, and the transmitter 60 and the reader 130 and is any one of four values “−1”, “0”, “1”, and “2”.

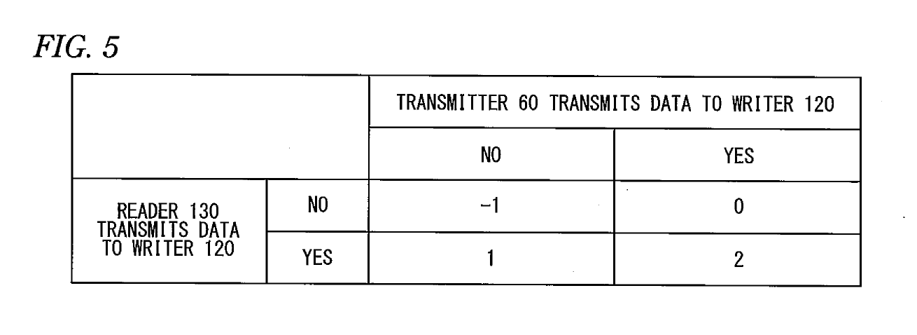

FIG. 5 is a diagram illustrating the relationship between the four values “4”, “0”, “1”, and “2”, and the transmitter 60 and the reader 130.

The value “−1” indicates a state in which the writer 120 does not acquire the information of the electronic apparatus through the reader 130 and the transmitter 60 and the value “0” indicates a state in which the writer 120 acquires the information of the electronic apparatus only from the transmitter 60. In addition, the value “1” indicates a state in which the writer 120 acquires the information of the electronic apparatus only through the reader 130, and the value “2” indicates a state in which the writer 120 acquires the information of the electronic apparatus through the reader 130 and the transmitter 60.

The first DB 100 stores the collection result of the daily information about, for example, the start time, the continuous start time, the maximum impact value, and the writing error to the HDD of the electronic apparatus 20 or the information about, for example, the start time, the continuous start time, and the maximum impact value of the electronic apparatus 20 until the latest measurement date, which are measured by the sensors 40, as shown in FIGS. 2 and 3. In addition, the information of electronic apparatuses which are not connected to the network is stored in the first DB 100 from the reader 130.

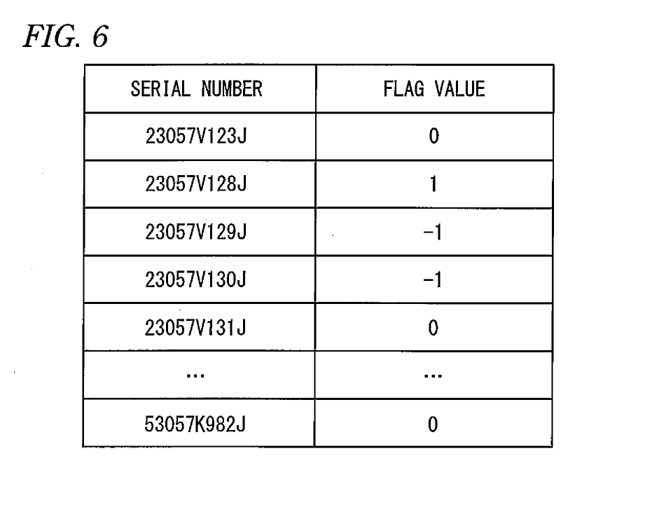

As shown in FIG. 6, the second DB 110 stores the flag value corresponding to the serial number of the electronic apparatus 20.

The reader 130 reads the information of external electronic apparatuses which are not connected to the server 30 through the network and transmits the read information to the writer 120. The external electronic apparatus which is not connected through the network is, for example, an electronic apparatus of the user which is used for repair. The reader 130 is directly connected to the external electronic apparatus by, for example, a cable and reads the information of the external electronic apparatus.

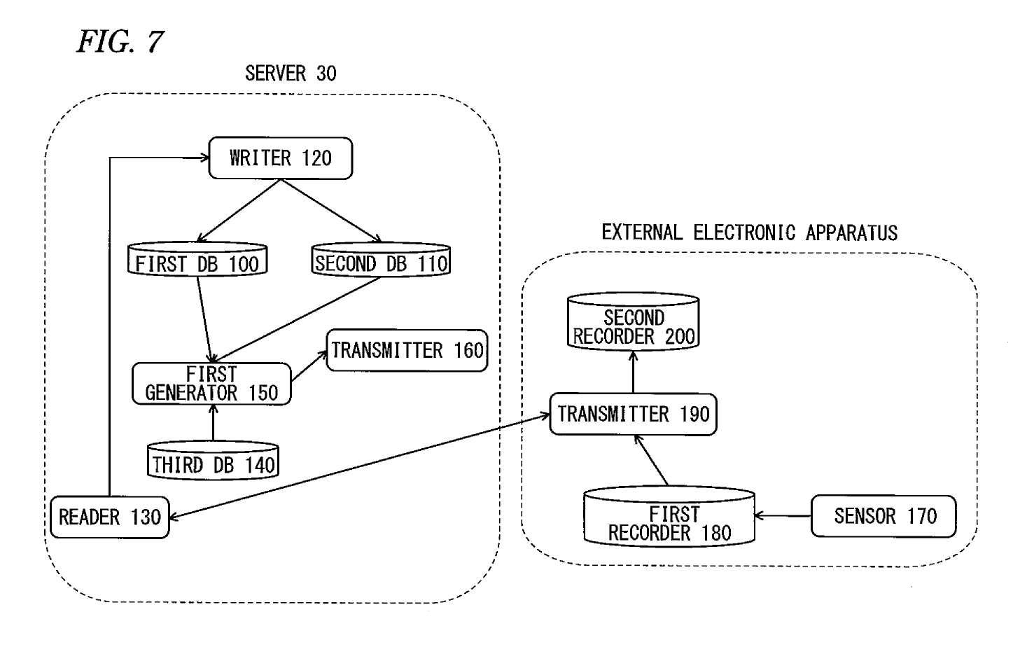

FIG. 7 is a block diagram illustrating the connection structure between the external electronic apparatus and the server 30. A sensor 170, a first recorder 180, a transmitter 190, and a second recorder 200 perform the same operations as the sensor 40, the first recorder 50, the transmitter 60, and the second recorder 70. In addition, the third recorder 80 and the calculator 90 are omitted: Next, the difference between the external electronic apparatus and the electronic apparatus 20 which is connected to the network will be described.

The reader 130 reads the transmission history recorded in the second recorder 200 through the transmitter 190. When the external electronic apparatus is not connected to the server 30 and there is no transmission history in the second recorder 200, the reader 130 sets the flag value “1” indicating that the information of the electronic apparatus is read only from the reader 130 and reads all of the information of the first recorder 180 through the transmitter 190. On the other hand, when there is a transmission history in the second recorder, the reader 130 sets the flag value “2” indicating that the information of the external electronic apparatus is read from the first recorder 180 through the transmitter 190. The writer 120 stores the information read by the reader 130 in the first DB 100 and stores the serial number of the external electronic apparatus and the flag value set by the reader 130 in the second DB 110.

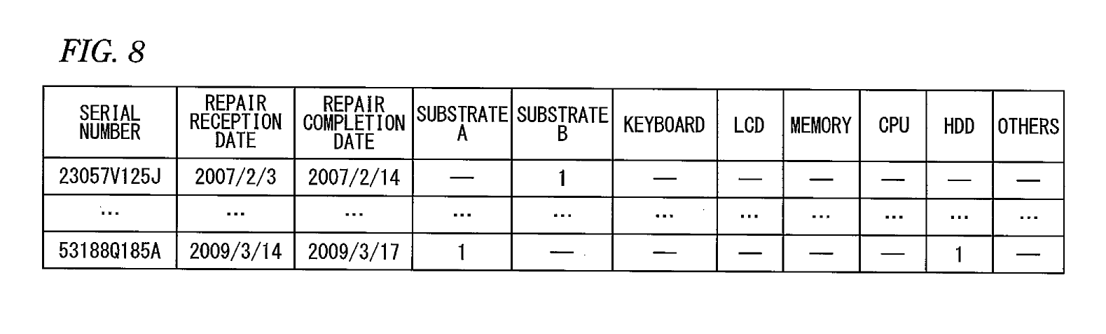

The third DB 140 stores repair information, such as the repair reception date, the repair completion data, and replacement parts of the external electronic apparatus of the user, as shown in FIG. 8. In FIG. 8, a number “1” indicates that the part has been repaired. For example, the number “1” indicates that a substrate A and an HDD have been repaired in the external electronic apparatus with a serial number 53188Q185A.

The first generator 150 generates parameters required to calculate the failure probability of the electronic apparatus from the information of the electronic apparatus stored in the first DB 100, the second DB 110, and the third DB 140 and transmits the parameters to the transmitter 160. In addition, the first generator 150 sequentially replaces the serial number with a sample number from 1, and uses information obtained by arranging numerical values, such as the start time, the continuous start time, and the maximum impact value of each sample, and a value indicating whether each sample is repaired, for a predetermined period of time. In this case, the flag values stored in the second DB 110 are also arranged for each sample.

Next, a method of generating the parameters required to calculate the failure probability of the electronic apparatus in the first generator 150 will be described.

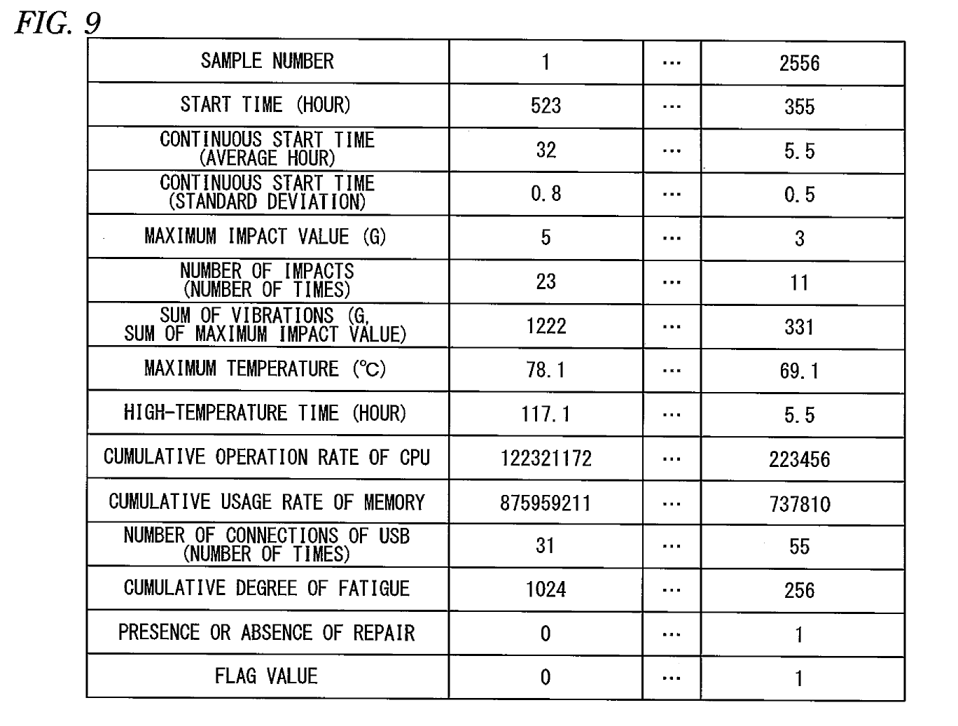

When x is information of the calculated values, such as the start time, the continuous start time, . . . , the degree of cumulative fatigue, and y indicates whether a repair is made from the information of the electronic apparatus shown in FIG. 9, learning data represented by the following expression 1 is obtained.

{(xᵢ,yᵢ)|i=1, . . . , N} (1)

where i is a positive integer from 1 to N and indicates a sample number.

Next, when Expression 1 is used, it is possible to calculate the failure probability qᵢ of an i-th sample using the following expression 2.

$${q}_{i} = \frac{1}{1 + exp ( β \cdot {x}_{i} + α )} \qquad ( 2 )$$

Here, parameters α and β of Expression 2 are calculated such that log likelihood l represented by the following expression 3 is the maximum.

$$l = {\sum }_{i = 1}^{N} ( {y}_{i} log {q}_{i} + ( 1 - {y}_{i} ) log ( 1 - {q}_{i} ) ) \qquad ( 3 )$$

In this case, for x, it is possible to select an optimal measurement information set using, for example, a stepwise method or a selection method based on sensitivity analysis, without using all of the information of the electronic apparatus shown in FIG. 9. As a result, the optimal measurement information set and the parameters α and β are calculated. The first generator 150 transmits the optimal measurement information set and the parameters α and β to the transmitter 160.

The transmitter 160 transmits and records the optimal measurement information set and the parameters α and β transmitted from the first generator 150 to the third recorder 80.

The third recorder 80 transmits the optimal measurement information set and the parameters α and β to the calculator 90.

The calculator 90 calculates the optimal failure probability using the optimal measurement information set and the parameters α and β transmitted from the third recorder 80 and displays the calculation result on a display unit (not shown) of the electronic apparatus 20. A method of calculating the failure probability in the calculator 90 will be described below.

First, the calculator 90 calculates failure probability q without using a flag value on the basis of the parameters α and β, using the following expression 4.

$$q = \frac{1}{1 + exp ( β \cdot x + α )} \qquad ( 4 )$$

The failure probability based on the information of the electronic apparatus which is collected in the first DB 100 through the transmitter 60 and the reader 130 is more than that of the apparatus on the market. Therefore, the failure probability q calculated by the above-mentioned Expression 4 is more than the actual failure probability and it is difficult to obtain the optimal failure probability.

In order to transmit the information of the electronic apparatus through the network, it is necessary to have the permission of the user. However, the permission of the user is not necessarily required. When the electronic apparatus is out of order, the probability of the electronic apparatus being carried to a repair center is substantially 100%. In this case, when the reciprocal of the rate at which the user permits the transmission of the information of the electronic apparatus is a load value w, w is calculated from the ratio of the flags using the following expression 5:

w=(the number of flags “1”+the number offlags “2”)/the number offlags “2” (5)

It is possible to estimate the number of electronic apparatuses which are not out of order, but are operating, that is, the total number of electronic apparatuses with flag values “−1” and “0” by multiplying the number of electronic apparatuses with a flag “0” by w.

In addition, it is possible to calculate an appropriate failure probability p including the transmission of information through the network on the basis of the load value w and the failure probability q calculated by Expression 4, using the following expression 6. This is failure probability when all users permit the transmission of the information of the electronic apparatuses, that is, the failure probability of all apparatuses.

$$p = \frac{q}{q + w ( 1 - q )} \qquad ( 6 )$$

Next, the operation of the electronic apparatus system 10 according to this embodiment will be described.

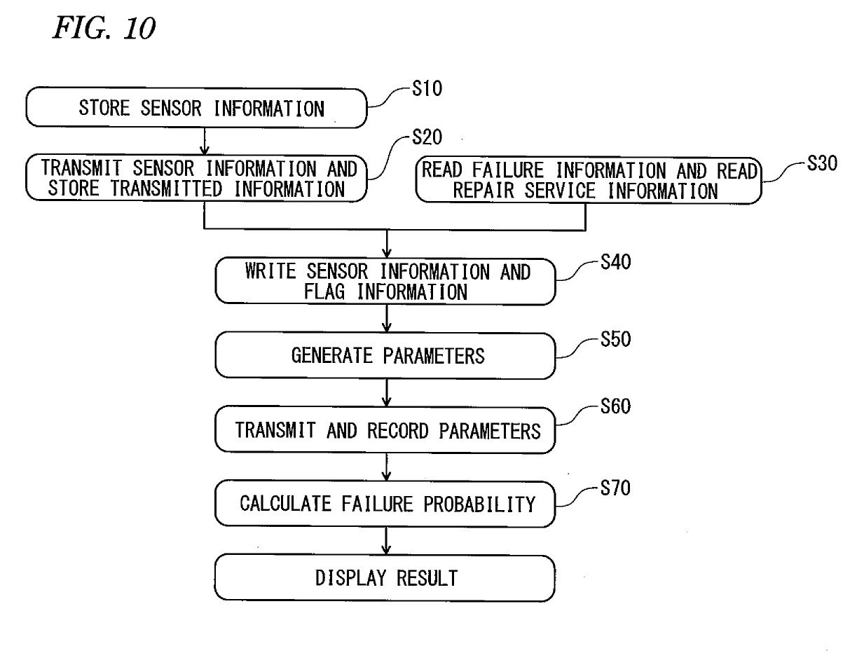

FIG. 10 is a flowchart illustrating the operation of the electronic apparatus system 10.

In Step S10, the sensors 40 detect information about, for example, the start time, the continuous start time, and the maximum impact value of the electronic apparatus, and record the information in the first recorder 50.

In Step S20, the transmitter 60 transmits the information about, for example, the start time, the continuous start time, and the maximum impact value of the electronic apparatus recorded in the first recorder 50 to the writer 120 and stores the transmission history in the second recorder 70.

In Step S30, the reader 130 transmits the information about, for example, the start time, the continuous start time, and the maximum impact value of an external electronic apparatus connected to the server to the writer 120.

In Step S40, the writer 120 stores the information transmitted from the transmitter 60 and the reader 130 in the first DB 100 and also stores the flag value for identifying the information of the electronic apparatus stored in the first DB 100 and the serial number in the second DB 110.

In Step S50, the first generator 150 generates parameters required to calculate the failure probability using the repair information of the electronic apparatus which is stored in the third DB 140 in advance and the information of the electronic apparatus about, for example, the start time, the continuous start time, and the maximum impact value of the electronic apparatus stored in the first DB 100, and transmits the parameters to the transmitter 160.

In Step S60, the transmitter 160 transmits and records the parameters generated by the first generator 150 to the third recorder 80.

In Step S70, the calculator 90 calculates the optimal failure probability using the parameters and the flag value recorded in the third recorder 80.

Finally, the calculation result of the calculator 90 is displayed on an external or internal display unit (not shown) connected to the electronic apparatus.

As described above, in this embodiment, it is possible to calculate the reciprocal w of the rate at which the user permits connection to the network, using the flag value. Therefore, it is possible to calculate the optimal failure probability using the reciprocal w.

### Second Embodiment

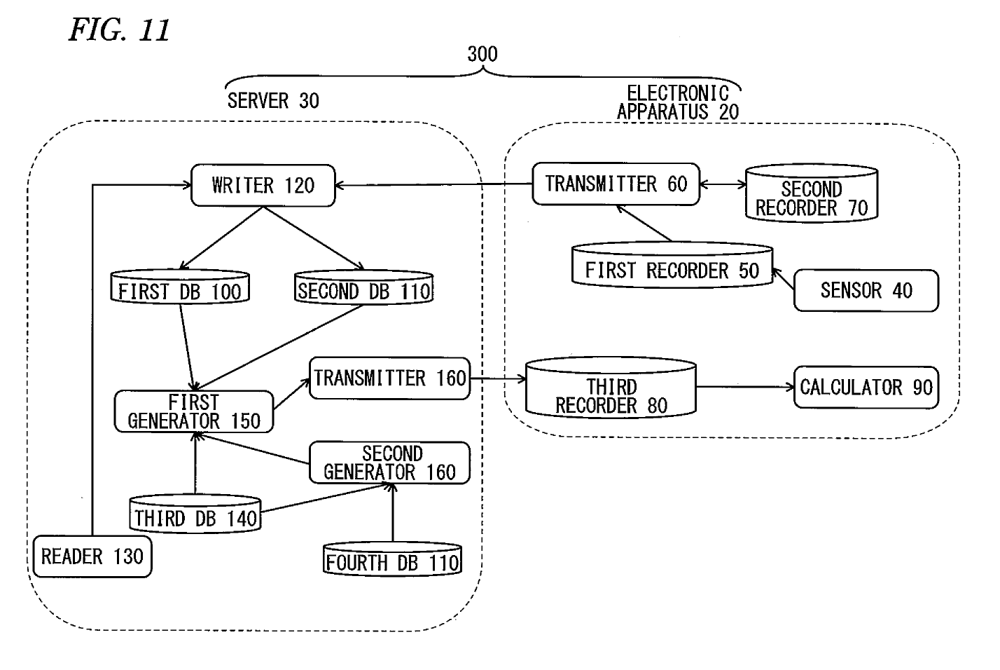

FIG. 11 is a block diagram illustrating an electronic apparatus system 300 according to a second embodiment of the invention. The electronic apparatus system 300 differs from the electronic apparatus system 10 in that it further includes a fourth DB 320 that stores information about, for example, the production date, serial number, shipment date, type, and manufacturing factory of an electronic apparatus and a second generator 330 that generates parameters for calculating the failure probability of the electronic apparatus in a specific set and the second generator 330 is connected to the third DB 140.

In the electronic apparatus system 300, a description of the same structure as that in the electronic apparatus system 10 will not be repeated.

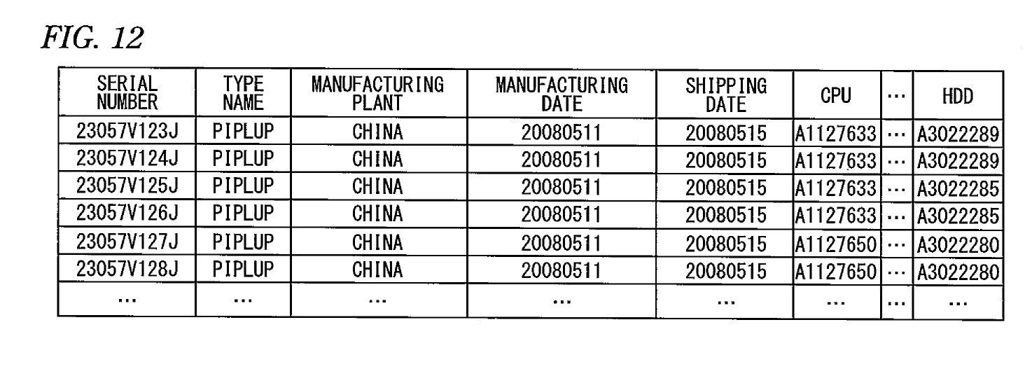

As shown in FIG. 12, the fourth DB 310 stores information about, for example, the production date, serial number, shipment date, type, and manufacturing factory of the electronic apparatus.

The second generator 330 generates parameters for calculating the failure probability of the electronic apparatus in a specific set from the third DB 140 and the fourth DB 310 and transmits the parameters to the first generator 150. Next, a method of generating the parameters for calculating the failure probability of the electronic apparatus in the second generator 330 will be described.

The second generator 330 can calculate the daily number of shipments s_{gt} for each specific set g from the repair information stored in the third DB 140. The specific set is determined by the information of the electronic apparatus stored in the fourth DB 310 and may be formed, for example, for each type of apparatuses. The electronic apparatuses which are of the same type and are manufactured at the same date may form the specific set. In this embodiment, it is assumed that the apparatuses of the same type are in the same specific set. In addition, it is possible to calculate the daily number of electronic apparatuses repaired in each specific set g on the basis of the information of the electronic apparatus stored in the third DB 140 and the information of the apparatus stored in the fourth DB 310. The number of electronic apparatuses repaired may be the number of specific repair parts with a number “1” in the repair information shown in FIG. 8 or the number of repair parts with a number “1” among the repair parts. In this embodiment, the number of electronic apparatuses repaired is the number of electronic apparatuses which belong to the specific set g and include the substrate A with a number “1” in FIG. 8. In addition, a predetermined period from T₁ to T₂ is given and the failure rate e_{g} of the electronic apparatus for the given period can be calculated by the following expression 7.

$${e}_{g} = \frac{{\sum }_{t = {T}_{1}}^{{T}_{2}} {m}_{gt}}{{\sum }_{t = {T}_{1}}^{{T}_{2}} {s}_{gt}} \qquad ( 7 )$$

In addition, a load value zᵢ when a specific set is considered for a specific period can be calculated by the following expression 8 on the basis of the failure rate e_{g}:

$$\begin{matrix}{z}_{i} = {e}_{g} ( no repaired part ) \\ = 1 - {e}_{g} ( a repaired part )\end{matrix} \qquad ( 8 )$$

where i is a positive integer and indicates a sample number.

The second generator 330 transmits the failure rate e_{g} and the load value zᵢ calculated by Expressions 7 and 8 to the first generator 150.

Similarly to the first embodiment, the first generator 150 calculates an optimal measurement information set and parameters α and β on the basis of the failure rate e_{g} and the load value zᵢ transmitted from the second generator 330 using, for example, a stepwise method and the following expressions 9 and 10 such that log likelihood l represented by the following Expression 9 is the maximum. The parameters are transmitted to the third recorder 80, similarly to the first embodiment.

$$\begin{matrix}l = {\sum }_{i = 1}^{N} {z}_{i} ( {y}_{i} log {r}_{i} + ( 1 - {y}_{i} ) log ( 1 - {r}_{i} ) ) & ( 9 ) \\ {r}_{i} = \frac{1}{1 + exp ( β \cdot {x}_{i} + α )} & ( 10 )\end{matrix}$$

The calculator 90 calculates failure probability q on the basis of the optimal measurement information set and the parameters α and β calculated by Expressions 9 and 10, using the following expression 11.

$$q = \frac{{e}_{g} r}{{e}_{g} r + ( 1 - {e}_{g} ) ( 1 - r )} \qquad ( 11 )$$

Finally, q is substituted into Expression 1 to calculate the optimal failure probability p.

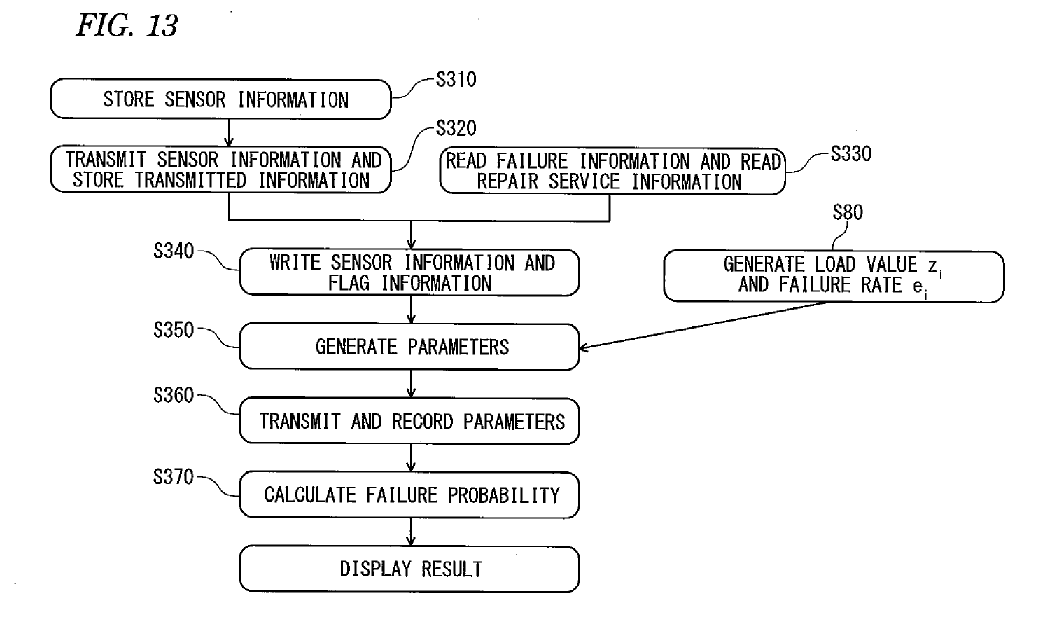

FIG. 13 is a flowchart illustrating the operation of the electronic apparatus system 300. In the electronic apparatus system 300, Steps S310, S320, S330, S340, S350, S360, and S370 are the same as Steps S10, S20, S30, S40, S50, S60, and S70 shown in FIG. 10 and thus a description thereof will not be repeated.

In Step S80, the second generator 310 generates the load value zᵢ and the failure rate eᵢ required to calculate the failure probability of the electronic apparatus in a specific set from the third DB 140 and the fourth DB 310 and outputs the parameters to the first generator 150.

According to this embodiment, it is possible to appropriately calculate the failure probability of the electronic apparatus in a specific set.

The above-described embodiments of the invention are illustrative embodiment, and the invention is not limited thereto. The above-described embodiments can be changed in various ways without departing from the scope and spirit of the invention.

The first generator 150 and the second generator 310 may function as one generator. The first storage unit 50, the second storage unit 70, and the third storage unit 80 may function as one storage unit. The first DB 100, the second DB 110, the third DB 140, and the fourth DB 320 may be integrated into one memory.

Although the several embodiments of the invention have been described above, they are just examples and should not be construed as restricting the scope of the invention. Each of these novel embodiments may be practiced in other various forms, and part of it may be omitted, replaced by other elements, or changed in various manners without departing from the spirit and scope of the invention. These modifications are also included in the invention as claimed and its equivalents.

What is claimed is:

1. An electronic apparatus system comprising:
an electronic apparatus; and
a server configured to receive usage information about usage status of the electronic apparatus, the server comprising:
a first database;
a second database;
a writer configured to store the usage information in the first database and to write a flag value into the second database, wherein the flag value indicates whether or not the usage information is transmitted from the electronic apparatus through a network;
a generator configured to generate a first parameter for calculating a failure probability of the electronic apparatus, based on the usage information and repair information of the electronic apparatus, wherein the repair information is stored in the server in advance; and
a transmitter configured to transmit the first parameter to the electronic apparatus.

2. The system of claim 1, wherein the electronic apparatus comprises:
a calculator that calculates a load value based on the flag value written into the second database of the server, wherein the load value represents a reciprocal of a rate at which a user permits data transmission from the electronic apparatus to the server.

3. The system of claim 2, wherein the calculator is configured to calculate the failure probability of the electronic apparatus, based on the load value and the first parameter.

4. The system of claim 1,
wherein the generator is configured to generate a repair rate of a specific set of electronic apparatuses based on the repair information, and
wherein the generator is configured to generate a second parameter for calculating the failure probability of the electronic apparatus, based on the repair rate, the usage information and the repair information.
